(19) United States
(12) Patent Application Publication
(10) Pub. No.: US 2023/0274213 A1
(43) Pub. Date: Aug. 31, 2023

(54) FIRST-PARTY COMPUTING SYSTEM SPECIFIC QUERY RESPONSE GENERATION FOR INTEGRATION OF THIRD-PARTY COMPUTING SYSTEM FUNCTIONALITY

(71) Applicant: OneTrust, LLC, Atlanta, GA (US)

(72) Inventors: Jonathan Blake Brannon, Smyrna, GA (US); Jason L. Sabourin, Brookhaven, GA (US); Subaramanian Viswanathan, San Ramon, CA (US); Manesh Haridas, Bangalore (IN); Milap Shah, Bengaluru (IN)

(73) Assignee: OneTrust, LLC, Atlanta, GA (US)

(21) Appl. No.: 18/314,027

(22) Filed: May 8, 2023

Related U.S. Application Data
(63) Continuation-in-part of application No. 17/151,334, filed on Jan. 18, 2021.
Application No. 17/151,334 is a continuation-in-part of application No. 16/901,662, filed on Jun. 15, 2020, now Pat. No. 10,909,488.
Application No. 16/901,662 is a continuation-in-part of application No. 16/808,496, filed on Mar. 4, 2020, now Pat. No. 10,796,260.
Application No. 16/808,496 is a continuation-in-part of application No. 16/714,355, filed on Dec. 13, 2019, now Pat. No. 10,692,033.
Application No. 16/714,355 is a continuation of application No. 16/403,358, filed on May 3, 2019, now Pat. No. 10,510,031.
Application No. 16/403,358 is a continuation of application No. 16/159,634, filed on Oct. 13, 2018, now Pat. No. 10,282,692.
Application No. 16/159,634 is a continuation-in-part of application No. 16/055,083, filed on Aug. 4, 2018, now Pat. No. 10,289,870.
Application No. 16/055,083 is a continuation-in-part of application No. 15/996,208, filed on Jun. 1, 2018, now Pat. No. 10,181,051.
Application No. 15/996,208 is a continuation-in-part of application No. 15/853,674, filed on Dec. 22, 2017, now Pat. No. 10,019,597.
Application No. 15/853,674 is a continuation-in-part of application No. 15/619,455, filed on Jun. 10, 2017, now Pat. No. 9,851,966.
Application No. 15/619,455 is a continuation-in-part of application No. 15/254,901, filed on Sep. 1, 2016, now Pat. No. 9,729,583.
(60) Provisional application No. 62/962,329, filed on Jan. 17, 2020.
(60) Provisional application No. 62/861,916, filed on Jun. 14, 2019.
(60) Provisional application No. 62/813,584, filed on Mar. 4, 2019.
(60) Provisional application No. 62/728,435, filed on Sep. 7, 2018.
(60) Provisional application No. 62/572,096, filed on Oct. 13, 2017.
(60) Provisional application No. 62/547,530, filed on Aug. 18, 2017.
(60) Provisional application No. 62/541,613, filed on Aug. 4, 2017.
(60) Provisional application No. 62/537,839, filed on Jul. 27, 2017.
(60) Provisional application No. 62/360,123, filed on Jul. 8, 2016.
(60) Provisional application No. 62/353,802, filed on Jun. 23, 2016.
(60) Provisional application No. 62/348,695, filed on Jun. 10, 2016.

(51) Int. Cl. G06Q 10/0635; G06Q 10/067; G06F 21/62; G06F 21/57; G06F 21/55; G06F 15/76

(52) U.S. Cl. CPC G06Q 10/0635; G06F 15/76; G06F 21/552; G06F 21/577; G06F 21/6245; G06Q 10/067; G06F 16/95

(57) ABSTRACT

A method, in various aspects, comprises: (1) receiving a query from a first party computing system related to integrating third party computing functionality into the first party computing system; (2) identifying a set of third party entities that provide the third party computing functionality; (3) accessing integration data; (4) identifying a set of reference entities, the set of reference entities including, for each respective third party entity, a respective reference entity that has previously integrated the third party computing into a respective reference entity computing system associated with the respective reference entity; (5) determining second integration data with respect to the set of reference entities integrating the third party computing functionality; (6) generating, based on the first integration data and the second integration data, data responsive to the query that is specific to the first party computing system; and (7) taking an action with respect to the data.

### CROSS-REFERENCE TO RELATED APPLICATIONS

This application is a continuation-in-part of U.S. Pat. Application Serial No. 17/151,334, filed Jan. 18, 2021, which claims priority from U.S. Provisional Pat. Application Serial No. 62/962,329, filed Jan. 17, 2020, and is also a continuation-in-part of U.S. Pat. Application Serial No. 16/901,662, filed Jun. 15, 2020, now U.S. Pat. No. 10,909,488, issued Feb. 2, 2021, which claims priority from U.S. Provisional Pat. Application Serial No. 62/861,916, filed Jun. 14, 2019, and is also a continuation-in-part of U.S. Pat. Application Serial No. 16/808,496, filed Mar. 4, 2020, now U.S. Pat. No. 10,796,260, issued Oct. 6, 2020, which claims priority from U.S. Provisional Pat. Application Serial No. 62/813,584, filed Mar. 4, 2019, and is also a continuation-in-part of U.S. Pat. Application Serial No. 16/714,355, filed Dec. 13, 2019, now U.S. Pat. No. 10,692,033, issued Jun. 23, 2020, which is a continuation of U.S. Pat. Application Serial No. 16/403,358, filed May 3, 2019, now U.S. Pat. No. 10,510,031, issued Dec. 17, 2019, which is a continuation of U.S. Pat. Application Serial No. 16/159,634, filed Oct. 13, 2018, now U.S. Pat. No. 10,282,692, issued May 7, 2019, which claims priority from U.S. Provisional Pat. Application Serial No. 62/572,096, filed Oct. 13, 2017 and U.S. Provisional Pat. Application Serial No. 62/728,435, filed Sep. 7, 2018, and is also a continuation-in-part of U.S. Pat. Application Serial No. 16/055,083, filed Aug. 4, 2018, now U.S. Pat. No. 10,289,870, issued May 14, 2019, which claims priority from U.S. Provisional Pat. Application Serial No. 62/547,530, filed Aug. 18, 2017, and is also a continuation-in-part of U.S. Pat. Application Serial No. 15/996,208, filed Jun. 1, 2018, now U.S. Pat. No. 10,181,051, issued Jan. 15, 2019, which claims priority from U.S. Provisional Pat. Application Serial No. 62/537,839, filed Jul. 27, 2017, and is also a continuation-in-part of U.S. Pat. Application Serial No. 15/853,674, filed Dec. 22, 2017, now U.S. Pat. No. 10,019,597, issued Jul. 10, 2018, which claims priority from U.S. Provisional Pat. Application Serial No. 62/541,613, filed Aug. 4, 2017, and is also a continuation-in-part of U.S. Pat. Application Serial No. 15/619,455, filed Jun. 10, 2017, now U.S. Pat. No. 9,851,966, issued Dec. 26, 2017, which is a continuation-in-part of U.S. Pat. Application Serial No. 15/254,901, filed Sep. 1, 2016, now U.S. Pat. No. 9,729,583, issued Aug. 8, 2017, which claims priority from: (1) U.S. Provisional Pat. Application Serial No. 62/360,123, filed Jul. 8, 2016; (2) U.S. Provisional Pat. Application Serial No. 62/353,802, filed Jun. 23, 2016; and (3) U.S. Provisional Pat. Application Serial No. 62/348,695, filed Jun. 10, 2016. The disclosures of all of the above patent applications are hereby incorporated herein by reference in their entirety.

### TECHNICAL FIELD

The present disclosure involves computer-implemented systems and processes for providing first party computing system specific query responses, for example, related to integrating third party computing system functionality into the first party computing system.

### BACKGROUND

A significant technical challenge encountered by computing systems is providing accurate query responses that are specific to a first party computing entity from which the query was received. For example, integration of third party computing functionality systems (e.g., software, storage, processing capacity, etc.) into a first party computing system may be delayed based on various factors related to the first party computing system or the third party computing system providing the third party computing functionality. Delays in the integration may introduce risks associated with integrating the computer-related functionality provided by the third party computing system. For example, delays in integration of third party computing functionality (e.g., for the purposes of transferring data, storing data, implementing software functionality on the first party computing system that utilizes the data, etc.) into a first party computing system can unnecessarily continue to expose the first party computing system to risks that the third party computing functionality may otherwise address (e.g., by providing data encryption, password management, two factor authentication, and the like). Therefore, a need exists in the art for improved systems and methods for reducing risks associated with integrating third party computing functionality into entity computing systems, for example, by providing more accurate query responses related to determination of potential integration times and delays.

### SUMMARY

A method, in various aspects, comprises: (1) receiving, by computing hardware, a query from first party computing system related to integrating third party computing functionality into the first party computing system; (2) identifying, by the computing hardware, a set of third party entities that provide the third party computing functionality; (3) accessing, by the computing hardware, integration data related to each respective third party entity in the set of third party entities with relation to integration of the third party computing functionality; (4) identifying, by the computing hardware, a set of reference entities, the set of reference entities including, for each respective third party entity, a respective reference entity that has previously integrated the third party computing functionality from the respective third party entity into a respective reference entity computing system associated with the respective reference entity; (5) determining, by the computing hardware, second integration data with respect to the set of reference entities integrating the third party computing functionality; (6) generating, by the computing hardware based on the first integration data and the second integration data, data responsive to the query, the data comprising at least a respective integration delay prediction for the third party computing functionality for each respective third party entity that is specific to the first party computing system; and (7) taking an action with respect to the integration delay prediction.

In some aspects, the actions include one or more of: (1) generating, by the computing hardware, a user interface that includes a listing of each respective third party entity that increases or decreases a ranking of each respective third party entity in the listing based on the respective integration delay prediction; or (2) initiating, by the computing hardware, network communication or computing operations for integrating the third party computing functionality from a particular third party entity of the set of third party entities into the first party computing system.

In some aspects, identifying the set of reference entities comprises: (1) accessing, by the computing hardware, a first a set of attributes for the first party computing system; (2) identifying, by the computing hardware, a set of potential reference entities, each respective potential reference entity having a second set of attributes; (3) comparing, by the computing hardware, the first set of attributes to the second set of attributes to identify a respective set of shared attributes for each potential reference entity; and (4) determining which respective set of shared attributes includes at least a threshold number of shared attributes. In particular aspects, generating the data responsive to the query further comprises generating each respective integration delay prediction by: (1) identifying, by the computing hardware, each respective reference entity that has previously integrated the third party computing functionality from each respective third party entity; (2) determining, for each respective reference entity that has previously integrated the third party computing functionality from each respective third party entity, from the second integration data, a respective actual integration time; and (3) generating each respective integration delay prediction based on each respective actual integration time.

In some aspects, the method comprises modifying each respective integration delay prediction based on one or more of: (1) a number of the respective set of shared attributes for each respective reference entity; or (2) a relation between each respective actual integration time and a respective predicted integration time for each respective reference entity that had previously integrated the third party computing functionality from each respective third party entity prior to integration. In some aspects, identifying the set of reference entities comprises: (1) determining, by the computing hardware, a first geographic location of the first party computing system; and (2) identifying the set of reference entities by determining that each respective reference entity computing system is in the first geographic location. In some aspects, generating the data responsive to the query comprises using a limited portion of the first integration data and second integration data to calculate each respective integration delay prediction, where the limited portion includes data related to prior integrations of the third party computing functionality that included at least one of: a similar volume of data encompassed by integrating the third party computing functionality into the first party computing system; a similar time period in which the third party computing functionality is planned to be integrated into the first party computing system; or a reference entity that operates in a related field to the first party computing system.

A system, in some aspects, comprises: (1) a non-transitory computer-readable medium storing instructions; and (2) a processing device communicatively coupled to the non-transitory computer-readable medium, wherein the processing device is configured to execute the instructions and thereby perform operations comprising: (1) receiving, from a fist party computing system having a first set of attributes, a first request to integrate third party computing functionality into the first party computing system; (2) identifying a set of third party computing systems that provide the third party computing functionality; (3) accessing tenant computing system integration data for the third party computing functionality, the tenant computing system integration data comprising integration data for each of a plurality of tenant computing systems operated by respective tenant entities that have previously integrated the third party computing functionality; (4) generating a respective integration timing prediction for each third party computing system in the set of third party computing systems with respect to integrating the third party computing functionality into the first party computing system based on the tenant computing system integration data; (5) customizing each respective integration timing prediction to the first party computing system by: (A) identifying a subset of the plurality of tenant computing systems that share a subset of the first set of attributes; and (B) generating a modified respective integration timing prediction for each third party computing system based on a subset of the tenant computing system integration data that omits the tenant computing system integration data for the plurality of tenant computing systems that are not in the subset of the plurality of tenant computing systems; (6) generating a graphical user interface comprising a listing of the set of third party computing systems and an indication of the modified respective integration timing prediction; and (7) providing the graphical user interface to a user computing device in the first party computing system. In some aspects, the operations further comprise increasing or decreasing a ranking of each third party computing system in the listing of the set of third party computing systems based on each modified respective integration timing prediction.

In particular aspects, customizing each respective integration timing prediction to the first party computing system further comprises: (1) determining a number of shared attributes between the subset of the plurality of tenant computing systems and the first party computing system; and (2) generating each modified respective integration timing prediction for each third party by weighting the subset of the tenant computing system integration data according to the number of shared attributes for each of the subset of the plurality of tenant computing systems. In various aspects, the first set of attributes identify at least one of a geographic location of the first party computing system, an industry of a first entity that operates the first party computing system, a volume of data that will be utilized by the third party computing functionality, a desired time period for integrating the third party computing functionality, or a number of data infractions experienced by the first entity. In some aspects, customizing each respective integration timing prediction to the first party computing system further comprises modifying each modified respective integration timing prediction based on integration timing data for the first party computing system that defines an integration performance for the first party computing system with respect to one or more integration timing predictions for one or more prior third party computing functionality integrations by the first party computing system. In some aspects, accessing tenant computing system integration data comprises anonymizing the tenant computing system integration data prior to generating each respective integration timing prediction.

In some aspects, the first request to integrate the third party computing functionality into the first party computing system comprises at least one of: (1) a request to modify a provider of the third party computing functionality from a first third party computing system to a second third party computing system; or (2) a request to integrate the third party computing function, where the third party computing functionality is not currently available on the first party computing system.

A method, according to some aspects, comprises: (1) receiving, by computing hardware, a request to integrate functionality provided by a third party computing system operated by a third party entity having a first set of attributes into a first party computing system operated by a first party entity having a second set of attributes; (2) identifying, by the computing hardware, a set of third party entities that provide the functionality, the set of third party entities having a third set of attributes; (3) accessing, by the computing hardware, tenant computing system integration data for the functionality provided by the third party computing system, the tenant computing system integration data comprising integration data for each of a plurality of tenant computing systems operated by respective tenant entities that have previously integrated the functionality from any of the set of third party entities, the tenant entities having a fourth set of attributes; (4) causing, by the computing hardware, at least one of a rules-based model or a machine-learning model to process the first set of attributes and the third set of attributes to generate a set of similarly situated third party entities to the third party entity; (5) causing, by the computing hardware, at least one of the rules-based model or the machine-learning model to process the second set of attributes and the fourth set of attributes to generate a set of similarly situated tenant entities to the first party entity; (6) analyzing, by the computing hardware, the tenant computing system integration data for the set of similarly situated tenant entities and the set of similarly situated third party entities to determine integration timing data for each of the set of similarly situated tenant entities and the set of similarly situated third party entities; (7) generating, by the computing hardware, a timing prediction for integrating the functionality provided by the third party computing system into the first party computing system based on the integration timing data that is specific to the first party computing system; and (8) causing, by the computing hardware, performance of an action with respect to the first party computing system based on the timing prediction.

In some aspects, the second set of attributes identify at least one of a geographic location of the first party computing system, an industry of the first party entity that operates the first party computing system, a volume of data that will be utilized by the functionality provided by the third party computing system, a desired time period for integrating the functionality provided by the third party computing system, or a number of prior data infractions experienced by the first party entity. In certain aspects, the action comprises one or more of: generating, by the computing hardware, a user interface that includes a listing of the set of third party entities that increases or decreases a ranking of the third party entity in the listing based on the timing prediction; or initiating, by the computing hardware, network communication or computing operations for integrating the functionality provided by the third party computing system into the first party computing system. In some aspects, the method further comprises generating the timing prediction by weighting the integration timing data according to a number of shared attributes between the first party entity and each entity in the set of similarly situated tenant entities.

In particular aspects, the method further comprises: (1) setting, by the computing hardware, a benchmark for completing integration of the functionality provided by the third party computing system; (2) tracking, by the computing hardware during integration of the functionality provided by the third party computing system into the first party computing system, actual timing data; and (3) facilitating at least one of modification of the timing prediction based on the actual timing data or transfer of the actual timing data to a third party computing entity for use in future timing determinations related to integration of the functionality provided by the third party computing system. In various aspects, the first set of attributes define at least a number of infractions incurred by the third party entity, a geographic location in which the third party entity operates, a relative integration time for the third party entity compared to pre-integration predicted integration times, or a number of prior integrations of the functionality provided by the third party computing system.

### BRIEF DESCRIPTION OF THE DRAWINGS

In the course of this description, reference will be made to the accompanying drawings, which are not necessarily drawn to scale, and wherein:

FIG. 1 depicts an example of a computing environment that can be used for generating first party computing system specific timing data for integrating functionality provided by a third party computing system into the first party computing system in accordance with various aspects of the present disclosure;

FIG. 2 depicts an example of a process for initiating third party computing system functionality integration into a first party computing system in accordance with various aspects of the present disclosure;

FIG. 3 depicts an example of a process for identifying similarly situated third party entities to provide more first party computing system specific timing data in accordance with various aspects of the present disclosure;

FIG. 4 depicts an example of a process for identifying similarly situated tenant computing systems to a first party computing system to provide more first party computing system specific timing data in accordance with various aspects of the present disclosure;

FIG. 5 depicts an example of a process for facilitating integration of the third party computing system functionality from a particular third party computing system into the first party computing system in accordance with yet another aspect of the present disclosure;

FIG. 6 depicts an example of a system architecture that may be used in accordance with various aspects of the present disclosure; and

FIG. 7 depicts an example of a computing entity that may be used in accordance with various aspects of the present disclosure.

### DETAILED DESCRIPTION

### Overview

As noted above a significant challenge encountered by computing systems is providing accurate query responses that are specific to a first party computing entity from which the query originates. In particular, there are significant technical challenges related to providing query responses that account for particular attributes of a first party computing entity from which the query originates. For example, it can be particularly technically challenging to provide query responses related to integrating third party computing functionality into a first party computing system operated by the first party entity that are accurate with respect to the first party computing system (e.g., particularly when the first party computing system has not previously integrated the third party computing functionality, or has not previously integrated the particular third party computing functionality from a particular third party computing system). This may be particularly true when the queries relate to expected timing required to complete the integration of the third party computing functionality. Conventional query responses have the problem of returning voluminous, generic, non-personalized data and other results that are not specific to the first party computing system at issue, because such responses may not take into account the unique characteristics of the first party computing system seeking integration of the third party computing functionality.

Accordingly, various aspects of the present disclosure overcome many of the technical challenges mentioned above associated with providing accurate query responses related to the integration of third party computing functionality into a first party computing system. In particular, various aspects of the present disclosure provide improved methods for generating query results by identifying similarly situated computing entities to the first party computing system and using integration data from the prior integration of the third party computing functionality into respective similarly situated computing systems to determine more accurate query response data with respect to integration of the third party computing functionality by the first party computing system. Additionally, various aspects of the present disclosure provide improved methods for identifying similarly situated third party computing systems that provide particular third party computing functionality in order to provide more accurate integration timing results for use by a first party computing system (i.e., the entity that operates the first party computing system) in selecting from a set of third party computing systems to provide the third party computing functionality.

As further noted above, another significant challenge encountered by many organizations is the risk associated with integrating computer-related functionality provided by third party computing systems (e.g., software, storage, processing capacity, etc.) into a first party computing system (e.g., a tenant computing system). In particular, integrating third party computing system functionality into a first party computing system may include, for example, transferring data between the first party and third party computing systems, providing access to data stored on the first party computing system to the third party computing system, performing risk analyses on various aspects of the third party computing system, etc. As such, integrating third party computing system functionality into a first party computing system may introduce risks related to transferring data between the computing systems, providing access to the external, third party computing system, etc. For example, transferring data between computing systems (e.g., from a first party computing system to a third party computing system in order to provide computing functionality available at the third party computing system to the data) can expose the data to a significant risk of experiencing some type of data incident involving the data, such as a data breach leading to the unauthorized access of the data, a data loss event, etc. Delays in such transfers and other technical operations required to initiate and complete the integration can exacerbate such risks. As such, it may be technically difficult to integrate third party computing system functionality into a first party computing system without increasing the risk of such exposure.

Accordingly, various aspects of the present disclosure overcome many of the technical challenges mentioned above associated with integrating third party computing system functionality into a first party computing system by providing a third party computing system integration analysis computing system configured to generate more accurate timing/delay predictions for integrating particular third party computing functionality into a first party computing system. In particular, various aspects of the present disclosure provide improved query results that are specific to a first party computing system by generating timing predictions for integration of the third party computing functionality into the first party computing system by: (1) identifying similarly situated entity computing systems to the first party computing system; (2) determining integration data for each of the similarly situated entity computing systems with respect to the third party computing functionality; and (3) determining predictive integration data that is specific to the first party computing system based on the integration data for the similarly situated entities.

Furthermore, various aspects of the present disclosure provide a specific technique for using reference computing entities to improve computerized query results and/or search results. In some aspects, the third party computing system integration analysis computing system generates a listing of third party computing systems that provide particular third party computing functionality that is prioritized based on generated predictions related to integration of the third party computing functionality into the first party computing system. In various aspects, the generated predictions are based on similarly situated entity computing systems and their prior integration of the third party computing functionality (e.g., from particular third party computing systems). In this way, the third party computing system integration analysis computing system can provide, for each potential provider of third party computing functionality, a more accurate prediction of integration timing that takes into account, for example: (1) past third party computing functionality integration timing for the first party computing system with respect to other third computing functionality (i.e., third party computing functionality other than the third party computing functionality for which the first party computing system currently seeks integration); (2) past integration of the particular third party computing functionality at issue by reference computing systems that are similarly situated with the first party computing system; (3) etc. In this way, the third party computing system integration analysis computing system provides specifically tailored query results (e.g., related to specific computing functionality integration timing) that are specifically tailored to the unique characteristics of the first party computing system. These improved query results eliminate the inherent generic results of conventional searches or simple average integration timing data for a particular third party computing system by using integration data for the identified similarly situated entity computing systems to enhance third party computing functionality integration timing/delay predictions that are specific to a first party computing system.

In the course of this description, reference is made to integrating third party computing system functionality into a first party computing system (e.g., or other computing system). Integrating third party computing system functionality can include a third party computing system providing any computing functionality available on the third party computing system to the first party computing system. For example, in various aspects, integrating third party computing system functionality into a first party computing system can include initiating network communications between the third party computing system and the first party computing system; transferring data between the first party computing system and the third party computing system; providing access, to the first party computing system, to data storage available on the third party computing system; providing, by the third party computing system, one or more software applications for installation on the first party computing system; providing access, by the third party computing system, to one or more cloud-based software applications to the first party computing system; and the like.

### Example Computing Environment

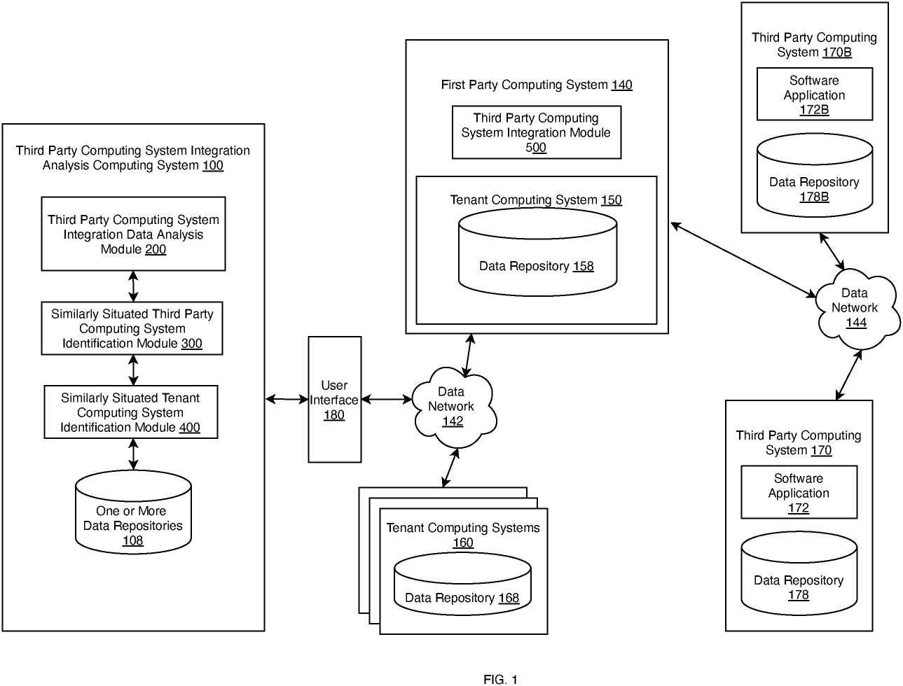

FIG. 1 depicts an example of a computing environment that can be used for determining integration data associated with integrating functionality provided by a third party computing system 170 (e.g., and/or second third party computing system 170B) into a first party computing system 140 (e.g., tenant computing system 150) and providing first party computing system 140 specific timing data with relation to integrating third party computing system functionality (e.g., from a third party computing system 170 or third party computing system 170B).

FIG. 1 depicts examples of hardware components of a third party computing system integration analysis computing system 100 according to some aspects. The third party computing system integration analysis computing system 100 is a specialized computing system that can be used for generating integration timing data for the integration of functionality provided by a third party computing system 170, 170B to a first party computing system 140, where the integration timing data is specific to the first party computing system 140. In some aspects, a first party computing system 140 may include a computing system that is operated by a particular entity (e.g., an organization). For example, the first party computing system 140 may include a collection of computing hardware and software over which an entity has control. A third party computing system 170, 170B may include a computing system that is operated by an entity other than the particular entity. For example, the third party computing system 170 may include computing hardware and software that the particular entity has no control over or access to, but which provides some functionality that the particular entity may desire to utilize (e.g., in conjunction with the first party computing system 140). In various aspects, the first party entity may provide compensation to the third party entity in exchange for utilizing the third party computing system functionality provided by the third party computing system 170. In various aspects, the particular third party computing functionality may be available (e.g., to the first party computing system 140) from more than one third party computing system (e.g., the third party computing system 170 or third party computing system 170B). In some aspects, the third party computing functionality may be available to the first party computing system 140 from a plurality of different third party entities. In some aspects, although different third party entities may provide the same (e.g., or similar) computing functionality, the functionality may be implemented or provided in different ways. In various aspects, a first party computing system 140 may select a particular third party computing system (e.g., 170 or 170B) to provide the third party computing functionality.

In various aspects, the third party computing system integration analysis computing system 100 includes a specialized computing system that may be used for generating integration timing data associated with integrating the functionality provided by the third party computing system 170 (e.g., and/or 170B) to the first party computing system 140. In some aspects, the timing data is specific to and/or customized based on the first party computing system 140 (e.g., or the first party entity). In some aspects, the third party computing system integration analysis computing system 100 utilizes integration data received from tenant computing systems 160 from prior integrations of the functionality provided by various third party computing systems (e.g., third party computing system 170 or 170B) into other first party systems (e.g., other first party systems associated with the tenant computing systems 160).

The third party computing system integration analysis computing system 100 can communicate with various computing systems, such as tenant computing systems 160 (e.g., over a data network 142, such as the internet). In various aspects, the third party computing system integration analysis computing system 100 can receive tenant computing system integration data (e.g., over the data network 142) related to integration, by each respective tenant computing systems 160, of the functionality provided by the third party computing system 170 and/or third party computing system 170B. The tenant computing system integration data may define, for example, data related to particular third party computing functionality integrated by each respective tenant computing system 160, as well as integration timing data related to each integration. The integration timing data may include, for example, timing of any particular aspect of the integration (e.g., necessary data transfer, API integration, physical hardware install requirements, integration risk analysis completion, etc.). The third party computing system integration analysis computing system 100 may store the tenant computing system integration data in one or more data repositories 108 on the third party computing system integration analysis computing system 100. The third party computing system integration analysis computing system 100 may include computing hardware performing a number of different processes in determining timing data for the first party computing system 140 associated with integrating the third party computing system functionality into the first party computing system 140 and specifying the timing data to the first party computing system 140 by identifying similarly situated tenant entities (and their associated tenant computing systems 160) to provide more first party specific timing data for the first party computing system 140. Specifically, according to various aspects, the third party computing system integration analysis computing system 100 executes: (1) a third party computing system integration data analysis module 300 to generate integration timing predictions for various third party computing systems that provide particular third party computing functionality, where the timing predictions are associated with integrating the third party computing system functionality into the first party computing system 140; (2) a similarly situated third party computing system identification module 300 to identify similarly situated third party computing entities to provide more accurate integration timing prediction comparisons for a particular first party computing system 140; and/or (3) a similarity situated third party computing system identification module 300 to identify similarly situated tenant computing systems to provide more accurate integration timing prediction comparisons for a particular first party computing system.

The third party computing system integration analysis computing system 100 can also communicate with a first party computing system 140 (e.g., over a data network 142, such as the internet). The first party computing system may include a computing system that desires to initiate, is initiating, in the process of integrating, or has completed an integration of the third party computing functionality (e.g., functionality provided by the third party computing system 170 or 170B). In various aspects, the first party computing system includes a tenant computing system 150. In various aspects, the third party computing system integration analysis computing system 100 may receive one or more requests from the first party computing system 140 (e.g., via a user interface 180) to identify one or more third party computing systems 170, 170B that provide particular third party computing functionality in addition to timing/delay data related to integrating the functionality provided by each third party computing system 170, 170B to the first party computing system 140.

According to various aspects, the first party computing system 140 may include computing hardware performing a number of different processes in initiating and implementing integration of third party computing system functionality into the first party computing system 140. Specifically, according to particular aspects, the first party computing system 140 executes a third party computing system integration module 600 to initiate a third party computing system functionality integration into the first party computing system 140 and track integration data during the integration.

The first party computing system can include a tenant computing system 150, which may include one or more data repositories 158. In various aspects, the tenant computing system 150 and the tenant computing systems 160 are part of a multi-tenant system in which a single instance of software and its supporting architecture (e.g., the third party computing system integration analysis computing system 100 and associated modules) serve multiple tenant systems. In such aspects, each of the tenant computing system 150 and the tenant computing systems 160 have respective data repositories 158, 168. In a particular aspect, a multi-tenant configuration may provide additional technical advantages to various aspects of the present disclosure. In particular, in some aspects, the third party computing system integration analysis computing system 100 may have access to each of the data repositories 168 for the respective tenant computing systems 168. In this way, although each tenant computing system 160, 150 maintains data in a secure data repository 168, 158 (e.g., or a secure portion of the one or more data repositories 108) the third party computing system integration analysis computing system 100 may access the integration data for respective tenant computing systems for use in determining and/or generating integration timing predictions that are specific to a first party entity. In various aspects, the third party computing system integration analysis computing system 100 may anonymize the tenant computing system integration data such that the data is available for use as described herein without revealing which particular one of the tenant computing systems 160 has integrated any particular functionality from any particular third party computing system. In various aspects, this configuration may provide additional technical advantages by providing improved design and implementation of various software applications for determining first party specific integration timing data and/or predictions, by providing access to data that may otherwise be unavailable to the software.

As shown in FIG. 1, the computing environment further includes a third party computing system 170, which can communicate with the first party computing system 140 over a data network 144. The third party computing system 170 can include one or more software applications 172 and a data repository 178. In various aspects, the third party computing system may have available computing functionality (e.g., such as data storage on the data repository, software functionality provided by the software application(s) 172, processing capability, etc.). In various aspects, the third party computing system may communicate (e.g., transmit data to, receive data from, etc.) the first party computing system 140. In various aspects, the third party computing system 170 may provide functionality to the first party computing system 140 (e.g., via the data network 144) during and/or following the integration of third party functionality provided by the third party computing system 170. The computing environment may further include a third party computing system 170B that is similar to and/or provides similar functionality as the third party computing system 170, but that may be operated by a separate entity.

The number of devices depicted in FIG. 1 are provided for illustrative purposes. In some aspects, different number of devices may be used. In various aspects, for example, while certain devices or systems are shown as single devices in FIG. 1, multiple devices may instead be used to implement these devices or systems. In still other aspects, a plurality of third party computing systems (i.e., beyond the third party computing system 170 or third party computing system 170B) may be available to provide particular third party computing functionality.

In some aspects, the third party computing system integration analysis computing system 100 can include one or more third-party devices such as, for example, one or more servers operating in a distributed manner. The third party computing system integration analysis computing system 100 can include any computing device or group of computing devices, and/or one or more server devices.

Although the data repositories 108, 158, 168, 178, 178B are shown as separate components, these components may include, in other aspects, a single server and/or repository, servers and/or repositories, one or more cloud-based servers and/or repositories, or any other suitable configuration.

### Third Party Computing System Integration Data Analysis Module

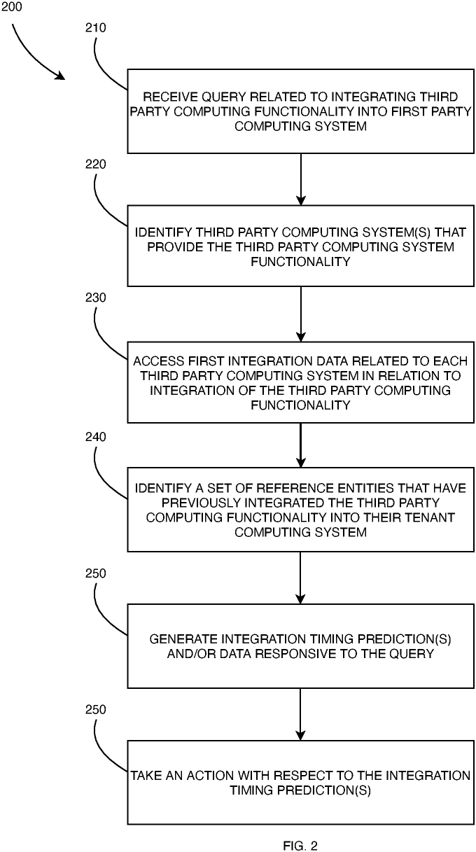

FIG. 2 depicts an example of process performed by a third party computing system integration data analysis module 200. This process include operations that the third party computing system integration analysis computing system 100 may execute to generate data responsive to a query related to integrating third party computing functionality into a first party computing system 140. For instance, the flow diagram shown in FIG. 2 may correspond to operations carried out, for example, by computing hardware found in the third party computing system integration analysis computing system 100 as the computing hardware executes the third party computing system integration data analysis module 200.

In various aspects, the third party computing system integration analysis computing system 100 (e.g., when executing steps related to the third party computing system integration data analysis module 200) receives a query related to integrating third party computing functionality into a first party computing system 140 and generating integration timing data that is specific to the first party computing system 140.

At operation 210, the third party computing system integration data analysis module 200 receives a query related to integrating third party computing functionality into a first party computing system 140. In various aspects, the third party computing system integration analysis computing system 100 receives the query from a first party computing system 140 (e.g., via a user interface 180 executing on a user computing device). In some aspects, the query includes a request related to integration timing data for integrating the third party computing functionality into the first party computing system 140. In particular aspects, the query relates to a particular third party computing system 170 (e.g., the query includes a request to generate integration timing prediction data related to the integration of the third party computing functionality from the particular third party computing system 170 into the first party computing system 140). In other aspects, the query relates to any third party computing system that provides the third party computing functionality (e.g., the query includes a request to generate integration timing prediction data related to the integration of the third party computing functionality from any third party computing system that provides the functionality into the first party computing system 140).

In particular aspects, the third party computing functionality may include any computing functionality provided by a third party computing system to the first party computing system. In some aspects, the query includes a request to initiate integration of the third party computing functionality into the first party computing system 140. In some aspects, the query includes a request for integration timing data for an in-process or completed integration. In still other aspects, the query includes a request for integration timing data related to a potential, planned, or future integration. In some aspects, the query may identify a particular desired third party computing functionality, which may, for example, be available in some form or other from a set of potential third party computing systems.

In some aspects, the query includes a query related to transferring a provider of particular third party computing functionality for the first party computing system from a first third party computing system 170 to a second third party computing system 170B. In this way, the query may seek data related to integration timing and/or transfer from the first third party computing system 170 to a second third party computing system 170B. A first party computing system may, for example, seek such transfer in response to a data breach at the first third party computing system 170, higher computing capability of the second third party computing system 170B (e.g., superior network communication speed, higher storage volume, lower transaction costs in terms of computing resources, etc.), or for any other suitable reason.

In various aspects, as discussed herein, integrating functionality from a third party computing system 170 into a first party computing system 140 may introduce risks related to transferring data between the computing systems, providing access, by the third party computing system 170 to the first party computing system 140, etc. Additionally, delays in such integration may introduce additional risks described herein. As such, in particular aspects, the query may include a request for timing data (e.g., timing data related to the integration of the third party computing functionality in the first party computing system 140) that is specific to the first party computing system). In this way, various aspects provide more accurate data responsive to such queries that can be used in selecting third party computing systems for providing the third party computing functionality to the first party computing system 140, and for other purposes described herein.

At operation 220, the third party computing system integration data analysis module 200 identifies third party computing systems that provide the third party computing functionality. As described herein, multiple different third party computing systems (e.g., at least third party computing system 170 and/or third party computing system 170B) may be available for integration of the third party computing functionality into the first party computing system 140 (e.g., because each of the different third party computing systems provide the third party computing functionality). In some aspects, the third party computing system may include a particular third party computing system 170 identified in the query at operation 210. In particular aspects, the third party computing system integration analysis computing system 100 may maintain a database (e.g., on the one or more data repositories 108) of third party computing systems/entities that defines each type of third party computing functionality offered by each third party computing system/entity. The third party computing system integration analysis computing system 100 may retrieve, from the database, identifying information for each of the third party computing systems that provide the third party computing functionality indicated in the query. In particular aspects, identifying the third party computing system(s) that provide the third party computing system functionality includes identifying one or more of: (1) an entity that operates each of the third party computing systems; (2) a geographic location of each of the third party computing systems (e.g., of physical computing hardware that makes up the third party computing system); (3) a type of entity that operates the third party computing system; and the like. In some aspects, when determining computing functionality integration timing estimates for a particular third party computing system, data from integration of that same third party functionality when provided by other third party entities may be utilized, particularly when those other third party entities are similarly situated with the third party entity (e.g., third party computing system 170) at issue.

In some aspects, when the query involves an integration timing request specific to a particular third party computing system 170, the third party computing system integration analysis computing system 100 may identify additional third party computing systems that provide the third party computing functionality. In this way, the third party computing system integration analysis computing system 100 may provide additional computing functionality integration data with respect to a set of third party computing systems, to provide additional options/providers of the third party computing functionality for selection by the first party computing system. The third party computing system integration analysis computing system 100 may thus further reduce potential risks associated with integrating third party computing functionality by making the first party computing system 140 aware of a third party computing system 170 from which the third party computing functionality is more readily available (e.g., could be integrated into the first party computing system 140 more quickly). More detail regarding the identification of third party computing systems is discussed below in the context of the similarly situated third party computing system identification module 300.

At operation 230, the third party computing system integration data analysis module 200 accesses first integration data related to each third party computing system in relation to integration of the third party computing functionality provided by each third party computing system. In some aspects, the third party computing system integration analysis computing system 100 may access data provided by each third party computing system related to integration of the third party computing functionality. The data may include, for example: (1) timing data related to the integration of the third party computing functionality by any entity computing system that has previously integrated the third party computing functionality from each particular third party computing system 170; (2) delay data related to the integration of the third party computing functionality from each third party computing system 170, which may indicate an actual integration time relative to a predicted integration time determined for the third party computing system 170 prior to integration by any entity computing system; (3) process specific timing data for each subprocess that made up the third party computing functionality integration process for each third party computing system 170 during prior integrations (e.g., timing data for a risk analysis process, data transfer process, computing operation initiation process, etc.); and/or (4) any other suitable data related to the integration of the third party computing functionality provided by each third party computing system 170 with respect to any entity computing system (e.g., tenant computing system 160). In other aspects, the third party computing system integration analysis computing system 100 may access data provided by each third party computing system related to integration of the third party computing functionality into a particular tenant computing system 160 (e.g., from each tenant computing system 160). For example, the third party computing system integration analysis computing system 100 may access data related to integration of the third party computing functionality provided by each identified third party computing system 170 by each tenant computing system 160 that has previously integrated the third party computing functionality from each third party computing system.

In various aspects, the first integration data may include, for example: (1) timing data related to the integration of the third party computing functionality by each tenant computing system 160 that has previously integrated the third party computing functionality from each particular third party computing system 170; (2) delay data related to the integration of the third party computing functionality from each third party computing system 170, which may indicate an actual integration time relative to a predicted integration time determined for the third party computing system 170 prior to integration by each tenant computing system 160; (3) process specific timing data for each subprocess that made up the third party computing functionality integration process for each third party computing system 170 during prior integrations (e.g., timing data for a risk analysis process, data transfer process, computing operation initiation process, etc.) by each tenant computing system 160; and/or (4) any other suitable data related to the integration of the third party computing functionality provided by each third party computing system 170 with respect to any entity computing system (e.g., tenant computing system 160).

In various aspects, the third party computing system integration analysis computing system 100 stores integration data for each tenant computing system 160 that integrates third party computing functionality for use in future query response generation (i.e., first party-computing system specific timing prediction data for a set of third party computing systems). In other aspects, the third party computing system integration analysis computing system 100 accesses a tenant computing system 160 (e.g., tenant computing systems 160) to access the first integration data for each tenant computing system 160. In some aspects, each tenant computing system 160 may store integration data in a particular data storage scheme (e.g., in a particular database on the respective data repository 168, in a particular schema, etc.). In s aspects, each tenant computing system 160 may store the integration data in a secure fashion, such as with encryption or requiring credentials to access. As such, in various aspects, the third party computing system integration analysis computing system 100 stores a decryption key or other decryption data and/or credentials for accessing and decrypting the first integration data at each tenant computing system. In this way, the first integration system may remain securely stored at each respective tenant computing system 160, while still being accessible to the third party computing system integration analysis computing system 100 for generating integration timing predictions for other computing entities. In some aspects, particular tenant computing system 160 can opt out of providing the first party integration dat. In other aspects, the third party computing system integration analysis computing system 100 can anonymize the first integration data for each tenant computing system 160 which may enable the third party computing system integration analysis computing system 100 to use the integration data while scrubbing an indication of the particular tenant computing system 160 from which it originated.

At operation 240, the third party computing system integration data analysis module 200 identifies a set of reference entities that have previously integrated the third party computing functionality into their tenant computing system. In various aspects, the set of reference entities include a subset of each of the tenant computing systems 160 that have previously integrated the third party computing functionality. In some aspects, the set of reference entities include a set of similarly situated tenant computing systems to the first party computing system. In some aspects, the third party computing system integration analysis computing system 100 may identify the set of reference entities based on entity type (e.g., whether any of the tenant computing systems 160 are operated by an entity that is a similar type of entity as the entity that operates the first party computing system 140). In other aspects, the third party computing system integration analysis computing system 100 may identify the set of reference entities based on a geographic region (e.g., whether any of the tenant computing systems 160 are operated by an entity that operates a similar geographic region as the entity that operates the first party computing system 140). In other aspects, the third party computing system integration analysis computing system 100 may analyze a set of attributes for each entity that operates each tenant computing system 160 and compare the sets of attributes to a set of attributes for the entity that operates the first party computing system in order to identify the set of reference entities (e.g., similarly situated entities). The third party computing system integration analysis computing system 100 may determine that a particular entity (e.g., tenant computing system 160) is a reference entity (e.g., similarly situated entity) in response to identifying at least a particular number of shared attributes between the particular entity and the entity that operates the first party computing system 140. Additional detail related to identifying reference entities for use in timing prediction generation is provided below in reference to the similarly situated tenant computing system identification module 400.

At operation 250, the third party computing system integration data analysis module 200 generates integration timing prediction(s) and/or data for the first party computing system. In some aspects, the third party computing system integration analysis computing system 100 generates a prediction related to timing required to integrate the third party computing functionality into the first party computing system 140 (e.g., for at least some of the third party computing systems 170 that provide the functionality). In some aspects, the timing prediction is based on the first integration data and the second integration data for the set of reference entities. For example, the third party computing system integration analysis computing system 100 may generate a prediction for integration timing for the first party computing system 100 that draws from a limited data set of only the set of reference entities and the actual integration timing for each of the reference entities to integrate the third party computing functionality into their respective computing systems. In some aspects, by calculating a predicted integration time using a limited dataset of actual integration times (e.g., from entities that are most closely correlated with the first party computing system at issue or from third party entities that are similarly situated to a third party entity that is providing the desired functionality), the third party computing system integration data analysis module 200 is able to provide query results in the form of integration timing predictions that are specific to the first party computing system.

In various aspects, the third party computing system integration analysis computing system 100 may process at least the first integration data and the second integration data using a rules-based model, a machine-learning model, or both to generate each respective timing prediction (e.g., to generate data responsive to the query received at operation 210). For example, the rules-based model, machine learning model, or combination of both may be configured to process the first integration data, the second integration data and/or the like in determining first party computing system specific timing predictions. In other aspects, the rules-based model, machine learning model, or combination of both may be configured to process integration data related to the first party computing system having integrated prior, different third party computing functionality to generate the timing prediction. For example, the rules-based model, machine learning model, or combination of both may be configured to generate a timing prediction by identifying the set of reference entities and aggregating actual integration times for that set of entities to generate an initial timing prediction.

For example, according to particular aspects, the third party computing system integration data analysis module 200 may involve using a rules-based model in generating each timing prediction. The rules-based model may comprise a set of rules that calculates a predicted integration time that weighs actual integration times derived from the second integration data. For example, the set of rules may define one or more rules for selecting actual integration times for use in predicting the integration timing for the first party computing systems 140 that are limited to integration times experienced only by reference entities to the first party computing system, limited to only reference entities with at least a particular number of shared attributes, etc. In other aspects, the set of rules may define one or more rules for assigning a weighting to each actual integration time that corresponds to a level of closeness in terms of similarity of situation between the first party computing system 140 and each identified reference entity (e.g., by assigning a higher weight to actual integration times for those reference entities with a higher number of shared attributes with the first party computing system 140 when using the actual integration times to generate a timing prediction). Accordingly, an entity (e.g., on the first party computing system 140, the third party computing system integration analysis computing system 100) may maintain the set of rules in some type of data storage, such as a database (e.g., the one or more data repositories 108), from which the third party computing system integration analysis computing system 100 can access the set of rules for generating the integration timing prediction.

According to other aspects, the third party computing system integration analysis computing system 100 may utilize a machine learning model in generating a timing prediction related to integrating the functionality provided by each third party computing system into the first party computing system 140. Here, the machine learning model may be trained using historical data on actual integration times by other tenants (e.g., tenant computing systems 160) that have integrated the functionality provided by the third party computing system 170. For instance, according to some aspects, the machine learning model may generate a timing prediction based on actual integration times experienced by tenant computing systems 160 in comparison to timing predictions for those integrations made by the third party computing system integration analysis computing system 100 prior to the integration. Accordingly, the machine learning model may be configured using a variety of different types of supervised or unsupervised trained models such as, for example, support vector machine, naive Bayes, decision tree, neural network, and/or the like. According to still other aspects, third party computing system integration analysis computing system 100 may use a combination of the rules-based model and the machine learning model in generating a query response (e.g., timing prediction).

In some aspects, the third party computing system integration data analysis module 200 may assign a first weight to a first integration time for a first integration of third party computing functionality provided by a first third party computing system into a first similarly situated tenant computing system and a second weight to a second integration time for a second integration of third party computing functionality provided by the first third party computing system into a second similarly situated tenant computing system. The system may further assign a third weight to a third integration time for a third integration of third party computing functionality provided by a second third party computing system into a third similarly situated tenant computing system and a fourth weight to a fourth integration time for a fourth integration of third party computing functionality provided by the second third party computing system into a fourth similarly situated tenant computing system. The third party computing system integration data analysis module 200 may then calculate a prediction as to the timing of integration of the third party computing functionality into a first party computing system by either the first and second third party computing system that takes into account the first weight and integration time, the second weight and integration time, the third weight and intention time, and the fourth weight and integration time. (e.g., [first weight] [first integration time] * [second weight] [second integration time] * [third weight] [third integration time] * [fourth weight] [fourth integration time] = predicted time). In some aspects, the process may add an additional modifier to account for which of the first or second third party computing system the prediction is being made.

At operation 260, the third party computing system integration data analysis module 200 takes an action with respect to the integration timing prediction and/or timing predictions. In various aspects the action may include initiating processing operations and/or network communications for facilitating integration of the third party computing functionality from a particular third party computing system 170 into the first party computing system 140 (e.g., a particular third party computing system 170 selected by a user). In other aspects, the action may include generating a graphical user interface for display on a user computing device (e.g., via a user interface 180). In some aspects, the third party computing system integration analysis computing system 100 may generate a graphical user interface that is customized based on the generated timing predictions. For example, the third party computing system integration analysis computing system 100 may generate a graphical user interface that increase or decreases a timing ranking for a particular third party computing system 170 within the graphical user interface.

For illustrative purposes, the third party computing system integration data analysis module 200 is described with reference to implementations described above with respect to one or more examples described herein. Other implementations, however, are possible. In some aspects, the steps in FIG. 2 may be implemented in program code that is executed by one or more computing devices such as the, the first party computing system 140, the third party computing system integration analysis computing system 100, or other system or combination of systems in FIG. 1. In some aspects, one or more operations shown in FIG. 2 may be omitted or performed in a different order. Similarly, additional operations not shown in FIG. 2 may be performed.

### Similarly Situated Third Party Computing System Identification Module

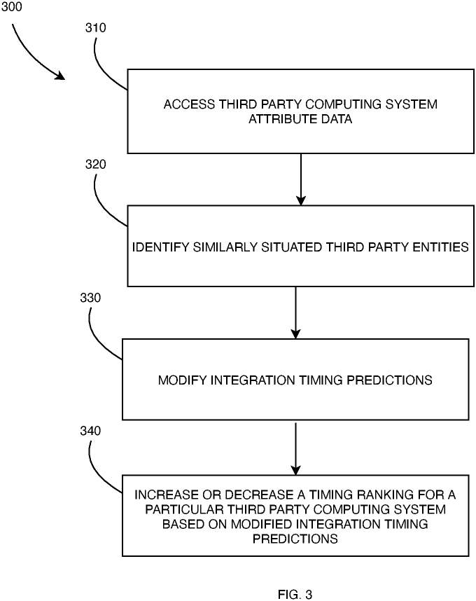

FIG. 3 depicts an example of a process performed by a similarly situated third party computing system identification module 300. This process may, for example, include operations that the third party computing system integration analysis computing system 100 may execute to identify similarly situated third party computing systems in order to provide more accurate timing data for integrating third party computing system functionality provided by similarly situated third party computing systems into the first party computing system 140. For instance, the flow diagram shown in FIG. 3 may correspond to operations performed by computing hardware found in the third party computing system integration analysis computing system 100 that executes the similarly situated third party computing system identification module 300.

At operation 310, similarly situated third party computing system identification module 300 accesses third party computing system attribute data. In some aspects, the third party computing system attribute data includes a set of attributes related to the third party computing system 170 or a set of third party computing systems. In some aspects, the set of attributes for the third party computing system 170 may indicate, for example: (1) a geographic location of the third party computing system (e.g., risk jurisdiction, operation region of an entity that operates the system, etc.); (2) a previous number of integrations of third party computing functionality provided by the third party computing system; (3) a number of regulatory infractions by the third party computing system; (4) a number of data breaches experienced by the third party computing system; (5) a number of tenant computing systems that have integrated computing functionality from the third party computing system; (6) one or more different types of computing functionality provided by the third party computing system; (7) a type of entity that operates the third party computing system; (8) a type of data processed by the third party computing functionality; (9) a type of the third party computing functionality; and/or (10) any other suitable attribute related to the third party computing system or the entity that operates it. Other attributes may include, for example; (1) network capability of any computing system described herein; (2) storage available at any computing system described herein; (3) storage redundancy/backup at any computing system described herein; (4) data events at any computing system described herein (including number, frequency, etc.); (5) number of failed integrations of computing functionality provided by or being provided to any computing system described herein; (6) timing of integration (e.g., time of year, end of quarter, time in the month, etc.); (7) a number of individual systems affected by the integration of computing functionality provided by or to any computing system described herein; (8) etc.

In operation 320, the similarly situated third party computing system identification module 300 identifies similarly situated third party entities to the third party entity (i.e., third party computing system). For example, the system may identify all third party computing systems with at least a particular number of shared attributes (e.g., by comparing the set of attributes to respective attributes for a set of potentially similarly situated third party entities). In some aspects, by identifying similarly situated entities, the system may use integration data for these similarly situated entities to provide more accurate timing predictions related to integration of the computing functionality form the third party entity.

At operation 330, the similarly situated third party computing system identification module 300 modifies integration timing predictions. The similarly situated third party computing system identification module 300 may, for example, modify an initial timing prediction by including additional data points from integration of the third party computing functionality from any of the similarly situated third party entities.

At operation 340, the similarly situated third party computing system identification module 300 increases or decreases a timing ranking for a particular third party computing system based on modified integration timing predictions. The system may, for example, modify the timing ranking to reflect a change in integration timing prediction following analysis of timing for similarly situated third party entities. The third party computing system integration analysis computing system 100 may modify data results showing a set of third party entities to increase or decrease a ranking of a particular entity within the set based on the modified prediction (e.g., to reflect a more accurate position of the third party entity within the set of third party entities with respect to computing functionality integration timing for a first party computing system). In some aspects, the third party computing system integration analysis computing system 100 may modify a user interface based on a modified ranking.

For illustrative purposes, the similarly situated third party computing system identification module 300 is described with reference to implementations described above with respect to one or more examples described herein. Other implementations, however, are possible. In some aspects, the steps in FIG. 3 may be implemented in program code that is executed by one or more computing devices such as the third party computing system integration analysis computing system 100, the first party computing system 140, or other system in FIG. 1. In some aspects, one or more operations shown in FIG. 3 may be omitted or performed in a different order. Similarly, additional operations not shown in FIG. 3 may be performed.

### Similarly Situated Tenant Computing System Identification Module

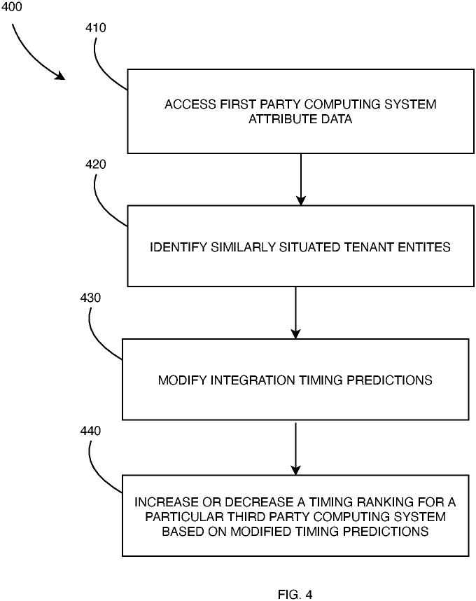

FIG. 4 depicts an example of a process performed by a similarly situated tenant computing system identification module 400. This process may, for example, include operations that the third party computing system integration analysis computing system 100 may execute to identify similarly situated tenant computing systems (e.g., reference entities) to a first party computing system 140 in order to provide more accurate timing data for integrating third party computing system functionality provided into the first party computing system 140. For instance, the flow diagram shown in FIG. 4 may correspond to operations performed by computing hardware found in the third party computing system integration analysis computing system 100 that executes the similarly situated tenant computing system identification module 400.

At operation 410, the similarly situated tenant computing system identification module 400 accesses first party computing system attribute data. In some aspects, the first party computing system attribute data includes attributes related to an entity that operates the first party computing system 140. In other aspects, the first party computing system attribute data includes attributes related to the first party computing system 140. In still other aspects, the first party computing system attribute data includes data related to the third party computing functionality being sought by the first party computing system 140.

In some aspects, the set of attributes for the first party computing system 140 may indicate, for example: (1) a geographic location of the first party computing system (e.g., risk jurisdiction, operation region of an entity that operates the system, etc.); (2) a previous number of integrations of third party computing functionality into the first party computing system; (3) a number of regulatory infractions experienced by the first party computing system; (4) a number of data breaches experienced by the first party computing system; (5) a type of entity that operates the first party computing system; and/or (6) any other suitable attribute related to the third party computing system or the entity that operates it. In other aspects, the set of attributes may indicate: (1) a volume of data that will be transferred to or accessed by the third party computing system during and/or following integration of the third party computing functionality; (2) other third party entities from which the first party computing system has integrated functionality previously; (3) a time of year or time period in which the integration will be initiated; (4) a performance of the first party computing system in integrating prior third party computing functionality with respect to timing estimates for the prior integration; (5) etc. Other attributes may include, for example; (1) network capability of any computing system described herein; (2) storage available at any computing system described herein; (3) storage redundancy/backup at any computing system described herein; (4) data events at any computing system described herein (including number, frequency, etc.); (5) number of failed integrations of computing functionality provided by or being provided to any computing system described herein; (6) timing of integration (e.g., time of year, end of quarter, time in the month, etc.); (7) a number of individual systems affected by the integration of computing functionality provided by or to any computing system described herein; (8) etc.

In operation 420, the similarly situated tenant computing system identification module 400 identifies similarly situated tenant entities. For example, the third party computing system integration analysis computing system 100 may identify all tenant computing systems with at least a particular number of shared attributes (e.g., by comparing the set of attributes to respective attributes for a set of potentially similarly situated tenant entities). In some aspects, by identifying similarly situated entities, the system may use integration data for these similarly situated entities to provide more accurate timing predictions related to integration of the computing functionality by the first party entity.

At operation 430, the similarly situated tenant computing system identification module 400 modifies integration timing predictions. The similarly situated third party computing system identification module 300 may, for example, modify an initial timing prediction by including additional data points from integration of the third party computing functionality by any of the similarly situated tenant entities. In particular aspects, the third party computing system integration analysis computing system 100 assigns a number of shared attributes to each similarly situated tenant entity and weights the actual integration time for each respective similarly situated entity according to the number of shared attributes when suing the actual integration times to generate a prediction. For example, the third party computing system integration analysis computing system 100 may assign a relatively higher weighting factor to an actual integration time for a similarly situated tenant entity with a high number of shared attributes, while assigning a relatively lower weighting factor to an actual integration time of a similarly situated entity with a lower number of shared attributes. In this way, the third party computing system integration analysis computing system 100 may provide timing predictions that are more weighted toward the most similarly situated tenant entities to the first party computing system in order to provide even more accurate data responsive to a query related to the integration of the third party computing functionality.

At operation 440, the similarly situated tenant computing system identification module 400 increases or decreases a timing ranking for a particular third party computing system based on modified timing predictions. As noted herein, this may include altering an order or ranking of a particular third party computing system within a listing of a set of third party computing systems that provide certain functionality. The ranking may, for example, reflect relative timing predictions that are specific to the first party computing system at issue, having been determined using techniques described herein. In some aspects, the third party computing system integration analysis computing system 100 may modify a user interface based on a modified ranking.

For illustrative purposes, the similarly situated tenant computing system identification module 400 is described with reference to implementations described above with respect to one or more examples described herein. Other implementations, however, are possible. In some aspects, the steps in FIG. 4 may be implemented in program code that is executed by one or more computing devices such as the third party computing system integration analysis computing system 100, the first party computing system 140, or other system in FIG. 1. In some aspects, one or more operations shown in FIG. 4 may be omitted or performed in a different order. Similarly, additional operations not shown in FIG. 4 may be performed.

### Third Party Computing System Control Implementation Module

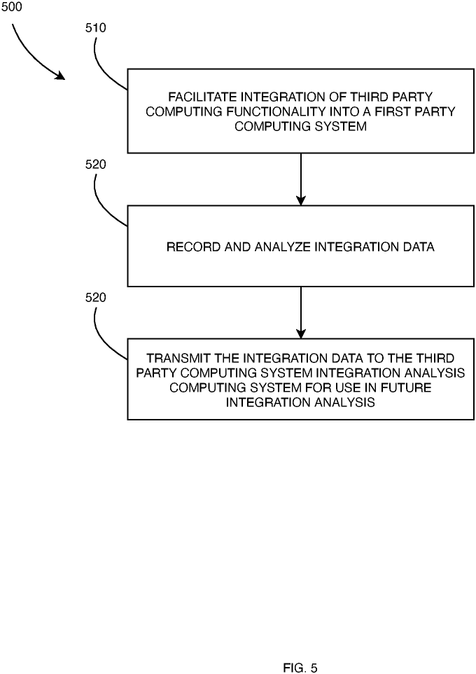

FIG. 5 depicts an example of a process, performed by a third party computing system control implementation module 500, according to various aspects. This process include operations that the first party computing system 140 may execute to facilitate integration of third party computing functionality provided by a third party computing system 170 into the first party computing system 140. For instance, the flow diagram shown in FIG. 5 may correspond to operations carried out, for example, by computing hardware found in, the first party computing system 140 as the computing hardware executes the third party computing system control implementation module 500.

At operation 510, the third party computing system control implementation module 500 facilitates integration of third party computing functionality into a first party computing system 140. In some aspects, the first party computing system 140 may initiate network communication and/or processing operations for integrating the third party computing functionality form a selected third party computing system 170 into the first party computing system 140. In other aspects, the first party computing system 140 initiates computerized workflows related to risk analyses and other risk mitigation processes related to the integration. In some aspects, the first party computing system 140 facilitates the integration of the third party computing functionality from the third party computing system 170 with the shortest predicted integration time. In other aspects, the first party computing system 140 may facilitate integration of the third party computing functionality from any suitable third party computing system 170.

At operation 520, the third party computing system control implementation module 500 records and analyzes integration data. In some aspects, the third party computing system control implementation module 500 may record actual timing data during the integration of the third party computing functionality. For example, the third party computing system control implementation module 500 may determine timing data for each subprocess that makes up the overall integration process. In some aspects, the third party computing system control implementation module 500 may compare actual timing data against one or more benchmarks set based on the generated predictions described herein. In some embodiments, the third party computing system integration analysis computing system 100 may use the performance of a first party computing system 140 in meeting timing benchmarks based on pre-integration predictions to modify future predictions for the first party computing system 140 and/or modify current benchmarks for uncompleted subprocesses. In some aspects, a first party computing system 140 that beats or exceeds timing benchmarks may be more likely to perform similarly relative to pre-determined benchmarks during future integrations (e.g., future stages of current integrations). As such, the third party computing system integration analysis computing system 100 may use benchmark data as training data for the machine learning module described above and/or to modify first party computing system specific predictions to provide more accurate predictions.

At operation 530, the third party computing system control implementation module 500 transmits the integration data to the third party computing system integration analysis computing system for use in future integration analysis. In some aspects, the actual integration data may provide training data to one or more machine learning models described herein. In other aspects, the actual integration data may provide more accurate predictions for future integrations.

For illustrative purposes, the third party computing system control implementation module 500 is described with reference to implementations described above with respect to one or more examples described herein. Other implementations, however, are possible. In some aspects, the steps in FIG. 5 may be implemented in program code that is executed by one or more computing devices such as the risk management and mitigation computing system 100, the first party computing system 140, or other system in FIG. 1. In some aspects, one or more operations shown in FIG. 5 may be omitted or performed in a different order. Similarly, additional operations not shown in FIG. 5 may be performed.

### Example Technical Platforms

Aspects of the present disclosure may be implemented in various ways, including as computer program products that include articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various aspects, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Bluray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatus, system, computing device, computing entity, and/or the like executing instructions stored on a computer-readable storage medium to perform certain steps or operations. Thus, various aspects of the present disclosure also may take the form of entirely hardware, entirely computer program product, and/or a combination of computer program product and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

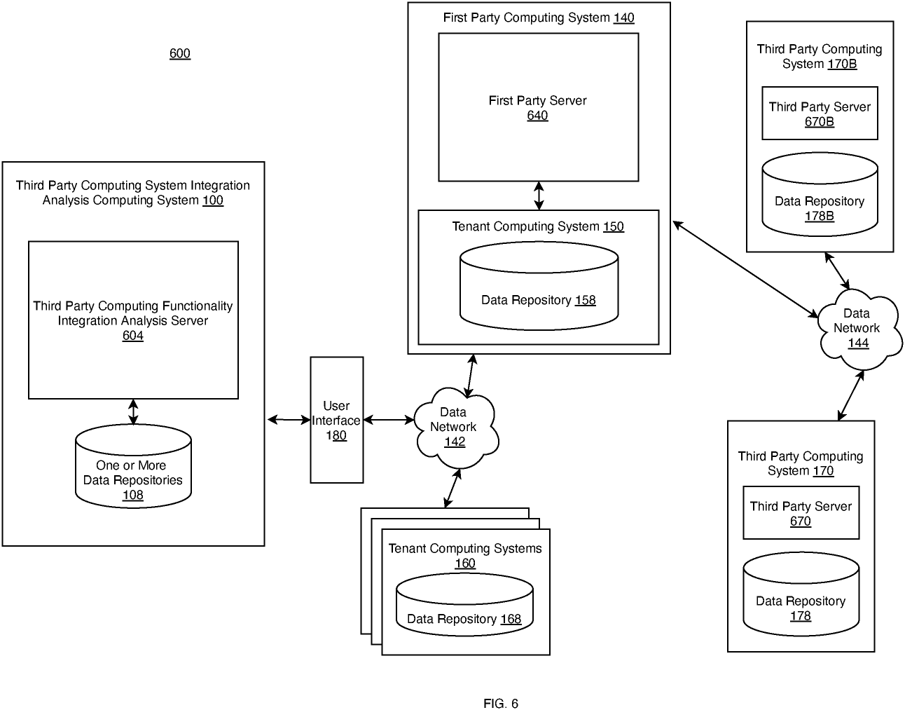

FIG. 6 depicts an example of a computing environment that can be used for a computing environment that can be used for generating first party computing system specific timing data for integrating functionality provided by a third party computing system into the first party computing system. Components of the system architecture 600 are configured according to various aspects to generate timing predictions and benchmarks associated with integrating third party computing system functionality into a first party computing system 140 where that functionality may be provided by various different third party computing systems 170.

The system architecture 600 according to various aspects may include a third party computing system integration analysis computing system 100 and one or more data repositories 108. The third party computing system integration analysis computing system 100 further includes a third party computing functionality integration analysis server 604. Although the third party computing system integration analysis computing system 100 and one or more data repositories 108 are shown as separate components, according to other aspects, these components may include a single server and/or repository, servers and/or repositories, one or more cloud-based servers and/or repositories, or any other suitable configuration.

In addition, the system architecture 600 according to various aspects may include a first-party computing system 140 that includes one or more first party servers 640 and a tenant computing system 150 comprising one or more data repositories 158. Although the first party server 640, first party computing system 140, tenant computing system 150, and one or more data repositories 158 are shown as separate components, according to other aspects, these components 170, 670, 150, 158 may include a single server and/or repository, servers and/or repositories, one or more cloud-based servers and/or repositories, or any other suitable configuration.

In addition, the system architecture 600 according to various aspects may include a third-party computing system 170 that includes one or more third party servers 670. Although the third party server 670 and third-party computing system 170 are shown as separate components, according to other aspects, these components 170, 670 may include a single server and/or repository, servers and/or repositories, one or more cloud-based servers and/or repositories, or any other suitable configuration.

In addition, the system architecture 600 according to various aspects may include a second third-party computing system 170B that includes one or more third party servers 670B. Although the third party server 670B and second third-party computing system 170B are shown as separate components, according to other aspects, these components 170, 670 may include a single server and/or repository, servers and/or repositories, one or more cloud-based servers and/or repositories, or any other suitable configuration.

In other aspects, the system architecture 600 may include a tenant computing system 160 comprising a data repository 168. Although the tenant computing system 160 and the data repository 168 are shown as separate components, according to other aspects, these components 160, 168 may include a single server and/or repository, servers and/or repositories, one or more cloud-based servers and/or repositories, or any other suitable configuration.

The third party computing functionality integration analysis server 604, first party server 640, and/or other components may communicate with, access, and/or the like with each other over one or more networks, such as via a data network 142 (e.g., a public data network, a private data network, etc.) and/or a data network 144 (e.g., a public data network, a private data network, etc.). In some aspects, the first party server 640, the third party computing functionality integration analysis server 604, and/or the third party server 670 may provide one or more interfaces that allow the first party computing system 140, the third party computing system 170, and/or the risk management and mitigation computing system 100 to communicate with each other such as one or more suitable application programming interfaces (APIs), direct connections, and/or the like.

### Example Computing Hardware

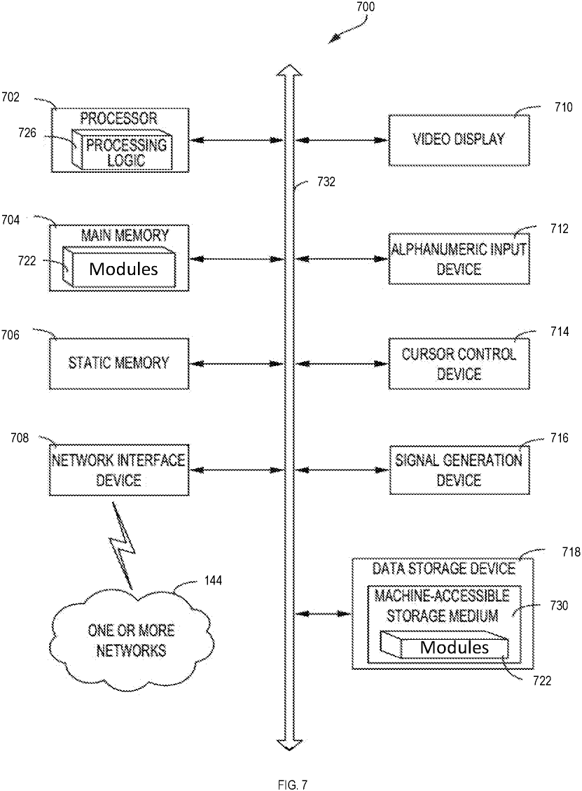

FIG. 7 illustrates a diagrammatic representation of a computing hardware device 700 that may be used in accordance with various aspects of the disclosure. For example, the hardware device 700 may be computing hardware such as a risk management and mitigation server 604 and/or a first party server 640 as described in FIG. 6. According to particular aspects, the hardware device 700 may be connected (e.g., networked) to one or more other computing entities, storage devices, and/or the like via one or more networks such as, for example, a LAN, an intranet, an extranet, and/or the Internet. As noted above, the hardware device 700 may operate in the capacity of a server and/or a client device in a client-server network environment, or as a peer computing device in a peer-to-peer (or distributed) network environment. According to various aspects, the hardware device 700 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 700 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 700 includes a processor 702, a main memory 704 (e.g., read-only memory (ROM), flash memory, dynamic random-access memory (DRAM) such as synchronous DRAM (SDRAM), Rambus DRAM (RDRAM), and/or the like), a static memory 706 (e.g., flash memory, static random-access memory (SRAM), and/or the like), and a data storage device 718, that communicate with each other via a bus 732.

The processor 702 may represent one or more general-purpose processing devices such as a microprocessor, a central processing unit, and/or the like. According to some aspects, the processor 702 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 702 may be one or more special-purpose processing devices such as an application specific integrated circuit (ASIC), a field programmable gate array (FPGA), a digital signal processor (DSP), network processor, and/or the like. The processor 702 can execute processing logic 726 for performing various operations and/or steps described herein.

The hardware device 700 may further include a network interface device 808, as well as a video display unit 710 (e.g., a liquid crystal display (LCD), a cathode ray tube (CRT), and/or the like), an alphanumeric input device 712 (e.g., a keyboard), a cursor control device 714 (e.g., a mouse, a trackpad), and/or a signal generation device 816 (e.g., a speaker). The hardware device 800 may further include a data storage device 718. The data storage device 718 may include a non-transitory computer-readable storage medium 730 (also known as a non-transitory computer-readable storage medium or a non-transitory computer-readable medium) on which is stored one or more modules 722 (e.g., sets of software instructions) embodying any one or more of the methodologies or functions described herein. For instance, according to particular aspects, the modules 722 include the third party computing system integration module 200, the computing system integration risk analysis module 300, the computing system control recommendation module 400, and the third party computing system control implementation module 500 as described herein. The one or more modules 722 may also reside, completely or at least partially, within main memory 704 and/or within the processor 702 during execution thereof by the hardware device 700 - main memory 8704 and processor 702 also constituting computer-accessible storage media. The one or more modules 722 may further be transmitted or received over a network 142 via the network interface device 708.

While the computer-readable storage medium 730 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 700 and that causes the hardware device 700 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects also may be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and the described program components (e.g., modules) and systems may be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

What is claimed is:

1. A method comprising:
receiving, by computing hardware, a query from a first party computing system related to integrating third party computing functionality into the first party computing system;
identifying, by the computing hardware, a set of third party entities that provide the third party computing functionality;
accessing, by the computing hardware, integration data related to each respective third party entity in the set of third party entities with relation to integration of the third party computing functionality;
identifying, by the computing hardware, a set of reference entities, the set of reference entities including, for each respective third party entity, a respective reference entity that has previously integrated the third party computing functionality from the respective third party entity into a respective reference entity computing system associated with the respective reference entity;
determining, by the computing hardware, second integration data with respect to the set of reference entities integrating the third party computing functionality;
generating, by the computing hardware based on the first integration data and the second integration data, data responsive to the query, the data comprising at least a respective integration delay prediction for the third party computing functionality for each respective third party entity that is specific to the first party computing system; and
taking, by the computing hardware, an action with respect to the integration delay prediction.

2. The method of claim 1, wherein the actions include one or more of:
generating, by the computing hardware, a user interface that includes a listing of each respective third party entity that increases or decreases a ranking of each respective third party entity in the listing based on the respective integration delay prediction; or
initiating, by the computing hardware, network communication or computing operations for integrating the third party computing functionality from a particular third party entity of the set of third party entities into the first party computing system.

3. The method of claim 1, wherein identifying the set of reference entities comprises:
accessing, by the computing hardware, a first a set of attributes for the first party computing system;
identifying, by the computing hardware, a set of potential reference entities, each respective potential reference entity having a second set of attributes;
comparing, by the computing hardware, the first set of attributes to the second set of attributes to identify a respective set of shared attributes for each potential reference entity; and
determining which respective set of shared attributes includes at least a threshold number of shared attributes.

4. The method of claim 3, wherein generating the data responsive to the query further comprises generating each respective integration delay prediction by:
identifying, by the computing hardware, each respective reference entity that has previously integrated the third party computing functionality from each respective third party entity;
determining, for each respective reference entity that has previously integrated the third party computing functionality from each respective third party entity, from the second integration data, a respective actual integration time; and
generating each respective integration delay prediction based on each respective actual integration time.

5. The method of claim 4, further comprising modifying each respective integration delay prediction based on one or more of:
a number of the respective set of shared attributes for each respective reference entity; or
a relation between each respective actual integration time and a respective predicted integration time for each respective reference entity that had previously integrated the third party computing functionality from each respective third party entity prior to integration.

6. The method of claim 1, wherein identifying the set of reference entities comprises:
determining, by the computing hardware, a first geographic location of the first party computing system; and
identifying the set of reference entities by determining that each respective reference entity computing system is in the first geographic location.

7. The method of claim 1, wherein generating the data responsive to the query comprises using a limited portion of the first integration data and second integration data to calculate each respective integration delay prediction, where the limited portion includes data related to prior integrations of the third party computing functionality that included at least one of:
a similar volume of data encompassed by integrating the third party computing functionality into the first party computing system;
a similar time period in which the third party computing functionality is planned to be integrated into the first party computing system; or
a reference entity that operates in a related field to the first party computing system.

8. A system comprising:
a non-transitory computer-readable medium storing instructions; and
a processing device communicatively coupled to the non-transitory computer-readable medium, wherein the processing device is configured to execute the instructions and thereby perform operations comprising:
receiving, from a fist party computing system having a first set of attributes, a first request to integrate third party computing functionality into the first party computing system;
identifying a set of third party computing systems that provide the third party computing functionality;
accessing tenant computing system integration data for the third party computing functionality, the tenant computing system integration data comprising integration data for each of a plurality of tenant computing systems operated by respective tenant entities that have previously integrated the third party computing functionality;
generating a respective integration timing prediction for each third party computing system in the set of third party computing systems with respect to integrating the third party computing functionality into the first party computing system based on the tenant computing system integration data;
customizing each respective integration timing prediction to the first party computing system by:
identifying a subset of the plurality of tenant computing systems that share a subset of the first set of attributes; and
generating a modified respective integration timing prediction for each third party computing system based on a subset of the tenant computing system integration data that omits the tenant computing system integration data for the plurality of tenant computing systems that are not in the subset of the plurality of tenant computing systems;
generating a graphical user interface comprising a listing of the set of third party computing systems and an indication of the modified respective integration timing prediction; and
providing the graphical user interface to a user computing device in the first party computing system.

9. The system of claim 8, wherein the operations further comprise increasing or decreasing a ranking of each third party computing system in the listing of the set of third party computing systems based on each modified respective integration timing prediction.

10. The system of claim 8, wherein customizing each respective integration timing prediction to the first party computing system further comprises:
determining a number of shared attributes between the subset of the plurality of tenant computing systems and the first party computing system; and
generating each modified respective integration timing prediction for each third party by weighting the subset of the tenant computing system integration data according to the number of shared attributes for each of the subset of the plurality of tenant computing systems.

11. The system of claim 8, wherein the first set of attributes identify at least one of a geographic location of the first party computing system, an industry of a first entity that operates the first party computing system, a volume of data that will be utilized by the third party computing functionality, a desired time period for integrating the third party computing functionality, or a number of data infractions experienced by the first entity.

12. The system of claim 8, customizing each respective integration timing prediction to the first party computing system further comprises modifying each modified respective integration timing prediction based on integration timing data for the first party computing system that defines an integration performance for the first party computing system with respect to one or more integration timing predictions for one or more prior third party computing functionality integrations by the first party computing system.

13. The system of claim 8, wherein accessing the tenant computing system integration data comprises anonymizing the tenant computing system integration data prior to generating each respective integration timing prediction.

14. The system of claim 8, wherein the first request to integrate the third party computing functionality into the first party computing system comprises at least one of:
a request to modify a provider of the third party computing functionality from a first third party computing system to a second third party computing system; or
a request to integrate the third party computing function, where the third party computing functionality is not currently available on the first party computing system.

15. A method comprising:
receiving, by computing hardware, a request to integrate functionality provided by a third party computing system operated by a third party entity having a first set of attributes into a first party computing system operated by a first party entity having a second set of attributes;
identifying, by the computing hardware, a set of third party entities that provide the functionality, the set of third party entities having a third set of attributes;
accessing, by the computing hardware, tenant computing system integration data for the functionality provided by the third party computing system, the tenant computing system integration data comprising integration data for each of a plurality of tenant computing systems operated by respective tenant entities that have previously integrated the functionality from any of the set of third party entities, the tenant entities having a fourth set of attributes;
causing, by the computing hardware, at least one of a rules-based model or a machine-learning model to process the first set of attributes and the third set of attributes to generate a set of similarly situated third party entities to the third party entity;
causing, by the computing hardware, at least one of the rules-based model or the machine-learning model to process the second set of attributes and the fourth set of attributes to generate a set of similarly situated tenant entities to the first party entity;
analyzing, by the computing hardware, the tenant computing system integration data for the set of similarly situated tenant entities and the set of similarly situated third party entities to determine integration timing data for each of the set of similarly situated tenant entities and the set of similarly situated third party entities;
generating, by the computing hardware, a timing prediction for integrating the functionality provided by the third party computing system into the first party computing system based on the integration timing data that is specific to the first party computing system; and
causing, by the computing hardware, performance of an action with respect to the first party computing system based on the timing prediction.

16. The method of claim 15, wherein the second set of attributes identify at least one of a geographic location of the first party computing system, an industry of the first party entity that operates the first party computing system, a volume of data that will be utilized by the functionality provided by the third party computing system, a desired time period for integrating the functionality provided by the third party computing system, or a number of prior data infractions experienced by the first party entity.

17. The method of claim 15, wherein the action comprises one or more of:
generating, by the computing hardware, a user interface that includes a listing of the set of third party entities that increases or decreases a ranking of the third party entity in the listing based on the timing prediction; or
initiating, by the computing hardware, network communication or computing operations for integrating the functionality provided by the third party computing system into the first party computing system.

18. The method of claim 15, further comprising generating the timing prediction by weighting the integration timing data according to a number of shared attributes between the first party entity and each entity in the set of similarly situated tenant entities.

19. The method of claim 15, further comprising:
setting, by the computing hardware, a benchmark for completing integration of the functionality provided by the third party computing system;
tracking, by the computing hardware during integration of the functionality provided by the third party computing system into the first party computing system, actual timing data; and
facilitating at least one of modification of the timing prediction based on the actual timing data or transfer of the actual timing data to a third party computing entity for use in future timing determinations related to integration of the functionality provided by the third party computing system.

20. The method of claim 15 wherein the first set of attributes define at least a number of infractions incurred by the third party entity, a geographic location in which the third party entity operates, a relative integration time for the third party entity compared to pre-integration predicted integration times, or a number of prior integrations of the functionality provided by the third party computing system.
